(19) United States
(12) Patent Application Publication
(10) Pub. No.: US 2026/0049165 A1
(43) Pub. Date: Feb. 19, 2026

(54) MODIFIED STYRENE ELASTOMER

(71) Applicant: Resonac Corporation, Tokyo (JP)

(72) Inventors: Rei SATAKE, Tokyo (JP); Kazuhiko MORI, Tokyo (JP); Shigeru KURIMOTO, Tokyo (JP)

(21) Appl. No.: 19/102,148

(22) PCT Filed: Aug. 14, 2023
(86) PCT No.: PCT/JP2023/029445

§ 371 Date: Feb. 7, 2025

(30) Foreign Application Priority Data
Aug. 16, 2022 (JP) 2022-129612

(51) Int. Cl. C08F 8/30; C08F 8/04; C08F 287/00

(52) U.S. Cl. CPC C08F 8/30; C08F 287/00; C08F 8/04

(57) ABSTRACT

An aspect of the present disclosure relates to a modified styrene-based elastomer having an N-substituted succinimide group containing a phenolic hydroxyl group, an isocyanate group, a blocked isocyanate group, a maleimide group, or a benzoxazine group in a side chain.

### TECHNICAL FIELD

The present disclosure relates to a modified styrene-based elastomer.

### BACKGROUND ART

Styrene-based elastomers constituted of copolymers of aromatic vinyl compounds and conjugated diene compounds, hydrogenated products thereof, and the like are used in various applications. It is known that styrene-based elastomers are modified with maleic anhydride and the like in order to impart properties such as adhesive properties and affinity (see, for example, Patent Literature 1).

### CITATION LIST

### Patent Literature

Patent Literature 1: JP 2013-028761 A

### SUMMARY OF INVENTION

### Technical Problem

An object of the present disclosure is to provide a novel modified styrene-based elastomer that is modified with a group having a specific structure.

### Solution to Problem

An aspect of the present disclosure relates to the following modified styrene-based elastomer.

[1] A modified styrene-based elastomer having an N-substituted succinimide group containing a phenolic hydroxyl group, an isocyanate group, a blocked isocyanate group, a maleimide group, or a benzoxazine group in a side chain.
[2] The modified styrene-based elastomer according to [1], in which the N-substituted succinimide group has a structure represented by the following Formula (1):

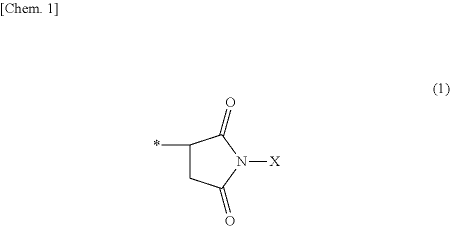

wherein in Formula (1), X represents a monovalent organic group having a phenolic hydroxyl group, an isocyanate group, a blocked isocyanate group, a maleimide group, or a benzoxazine group, and * represents a bonding portion.
[3] The modified styrene-based elastomer according to [1] or [2], in which the N-substituted succinimide group containing a phenolic hydroxyl group has a structure represented by the following Formula (2):

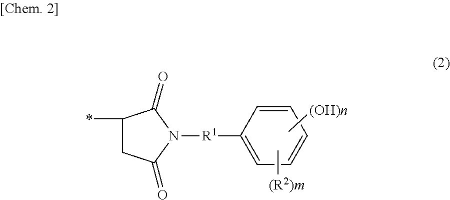

wherein in Formula (2), R¹ represents an alkylene group or a single bond, R² represents an alkyl group, m is 0 or 1, n is 1 or 2, and * represents a bonding portion.
[4] The modified styrene-based elastomer according to [1] or [2], in which the N-substituted succinimide group containing an isocyanate group has a structure represented by the following Formula (3):

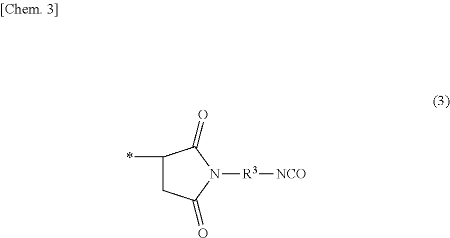

wherein in Formula (3), R³ represents an aliphatic hydrocarbon group, a hydrocarbon group having an aromatic ring, or an organic group having a urethane bond, and * represents a bonding portion.
[5] The modified styrene-based elastomer according to [1] or [2], in which the N-substituted succinimide group containing a blocked isocyanate group has a structure represented by the following Formula (4):

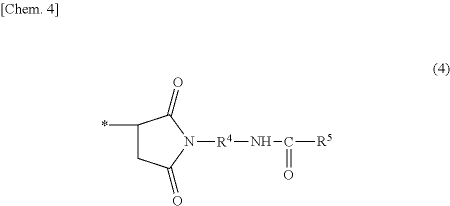

wherein in Formula (4), R⁴ represents a residue of a diisocyanate compound, R⁵ represents a residue of a blocking agent, and * represents a bonding portion.
[6] The modified styrene-based elastomer according to [1] or [2], in which the N-substituted succinimide group containing a maleimide group has a structure represented by the following Formula (5):

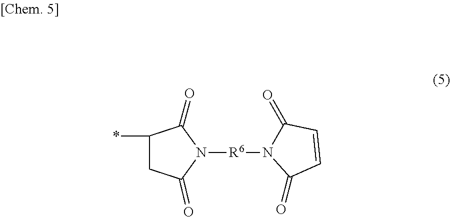

wherein in Formula (5), R⁶ represents a residue of a diamine compound.
[7] The modified styrene-based elastomer according to [1] or [2], in which the N-substituted succinimide group containing a benzoxazine group has a structure represented by the following Formula (6):

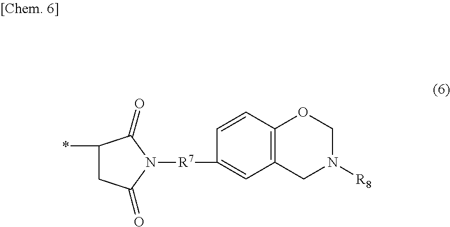

wherein in Formula (6), R⁷ represents an alkylene group, R⁸ represents an alkyl group, a phenyl group, or an allyl group, and * represents a bonding portion.

### Advantageous Effects of Invention

According to the present disclosure, it is possible to provide a novel modified styrene-based elastomer that is modified with a group having a specific structure.

### DESCRIPTION OF EMBODIMENTS

Hereinafter, suitable embodiments of the present disclosure will be described in detail. However, the present disclosure is not limited to the following embodiments. In the present specification, the term “step” includes not only an independent step but also a step that cannot be clearly distinguished from other steps as long as the intended action of the step is achieved. In the present specification, the term “layer” encompasses a structure having a shape formed on a part as well as a structure having a shape formed on the entire surface when observed in a plan view.

In the present specification, a numerical range indicated using “to” indicates a range including the numerical values before and after “to” as the minimum and maximum values, respectively. In numerical ranges described in stages in the present specification, the upper limit or lower limit in a numerical range in a certain stage may be replaced with the upper limit or lower limit in a numerical range in another stage. In a numerical range described in the present specification, the upper limit or lower limit in the numerical range may be replaced with values presented in Examples. In the present specification, in a case of referring to the amount of each component in a composition, the amount refers to the total amount of a plurality of substances present in the composition in a case where the plurality of substances corresponding to each component are present in the composition, unless otherwise specified. “A or B” means that it is only required to contain either A or B and both A and B may be contained. “Solids” refer to the non-volatile components in a resin composition excluding volatile substances (water, solvent and the like). In other words, “solids” refer to components other than the solvent that remain without volatilizing during drying of a resin composition described later, and also include components that are liquid, syrup-like, or waxy at room temperature (25° C.). [Modified styrene-based elastomer]

The modified styrene-based elastomer according to the present embodiment has an N-substituted succinimide group containing a phenolic hydroxyl group, an isocyanate group, a blocked isocyanate group, a maleimide group, or a benzoxazine group in the side chain. It is considered that the modified styrene-based elastomer has an N-substituted succinimide group, and is therefore less likely to undergo hydrolysis due to moisture in the air, and the like, and is thus excellent in stability, and the modified styrene-based elastomer contains at least one functional group selected from the group consisting of a phenolic hydroxyl group, an isocyanate group, a blocked isocyanate group, a maleimide group, and a benzoxazine group, therefore exhibits reactivity, and is thus capable of improving the properties of the cured product, such as heat resistance and strength.

The N-substituted succinimide group can be introduced by reacting a compound having a reactive group such as an amino group or an isocyanate group with the acid anhydride group of a styrene-based elastomer modified with maleic anhydride. The styrene-based elastomer may be a copolymer having a structural unit derived from a styrene-based compound and a structural unit derived from a conjugated diene compound.

Examples of the styrene-based compound include styrene, α-methylstyrene, p-methylstyrene, and p-tert-butylstyrene. Among these, styrene, α-methylstyrene, and 4-methylstyrene are preferred and styrene is more preferred from the viewpoints of availability and productivity.

Examples of the conjugated diene compound include 1,3-butadiene, 2-methyl-1,3-butadiene (isoprene), 1,3-pentadiene (piperylene), 1-phenyl-1,3-butadiene, 2,3-dimethyl-1,3-butadiene, 2-methyl-1,3-pentadiene, 3,4-dimethyl-1,3-hexadiene, and 4,5-diethyl-1,3-octadiene. Among these, 1,3-butadiene and isoprene are preferred from the viewpoints of availability and productivity.

The styrene-based elastomer may be a hydrogenated styrene-based elastomer in which at least a part of the structural unit derived from a conjugated diene compound is hydrogenated. Examples of the hydrogenated styrene-based elastomer include a hydrogenated styrene-butadiene-styrene block copolymer (SEBS) and a hydrogenated product of styrene-isoprene-styrene block copolymer. Examples of commercially available products of SEBS include TUFTEC (registered trademark) H series and M series manufactured by Asahi Kasei Corp.,

SEPTON (registered trademark) series manufactured by Kuraray Co., Ltd., and KRATON (registered trademark) G Polymer series manufactured by KRATON CORPORATION.

The styrene-based elastomer or hydrogenated styrene-based elastomer, which is modified with maleic anhydride, (hereinafter referred to as “maleic anhydride-modified styrene-based elastomer”) may be produced by reacting a styrene-based elastomer or hydrogenated styrene-based elastomer with maleic anhydride, or a commercially available product may be used.

The maleic anhydride-modified styrene-based elastomer can be produced, for example, by adding a radical generator to a mixture in which a styrene-based elastomer and maleic anhydride are dissolved in a solvent in a nitrogen atmosphere and reacting the maleic anhydride with the styrene-based elastomer. The reaction temperature may be 20° C. to 150° C. After the reaction, it is preferable to remove unreacted maleic anhydride by extraction from the viewpoint of suppressing side reactions.

As the radical generator, for example, an organic peroxide, an azo compound, and the like can be used. Examples of the organic peroxide include dicumyl peroxide, benzoyl peroxide, 2-butanone peroxide, tert-butyl perbenzoate, di-tert-butyl peroxide, 2,5-dimethyl-2,5-di(t-butylperoxy) hexane, bis(tert-butylperoxyisopropyl)benzene, and tert-butyl hydroperoxide. Examples of the azo compound include 2,2′-azobis(2-methylpropanenitrile), 2,2′-azobis(2-methylbutanenitrile), and 1,1′-azobis(cyclohexanecarbonitrile).

Examples of the solvent include butyl cellosolve, ethylene glycol monomethyl ether, propylene glycol monomethyl ether, methyl ethyl ketone, methyl isobutyl ketone, cyclohexanone, toluene, xylene, mesitylene, methoxyethyl acetate, ethoxyethyl acetate, butoxyethyl acetate, and ethyl acetate. These may be used singly or in mixture of two or more kinds thereof. Among these, toluene, xylene, and propylene glycol monomethyl ether are preferred from the viewpoint of solubility.

The N-substituted succinimide group may be a group having a structure represented by the following Formula (1).

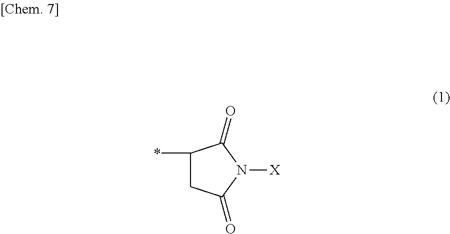

In Formula (1), X represents a monovalent organic group having a phenolic hydroxyl group, an isocyanate group, a blocked isocyanate group, a maleimide group, or a benzoxazine group, and * represents a bonding portion.

The N-substituted succinimide group containing a phenolic hydroxyl group may be a group having a structure represented by the following Formula (2).

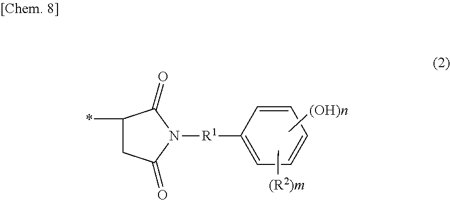

In Formula (2), R¹ represents an alkylene group or a single bond, R² represents an alkyl group, m is 0 or 1, n is 1 or 2, and * represents a bonding portion. Examples of the alkylene group for R¹ include a methylene group, an ethylene group, and a propylene group. Examples of the alkyl group for R² include a methyl group, an ethyl group, and a propyl group.

The modified styrene-based elastomer having an N-substituted succinimide group containing a phenolic hydroxyl group in the side chain (hereinafter referred to as “phenolic hydroxyl group-containing succinimide-modified styrene-based elastomer”) may be a reaction product of a maleic anhydride-modified styrene-based elastomer with an amine compound having a phenolic hydroxyl group. Examples of the amine compound having a phenolic hydroxyl group include tyramine, dopamine, 4-aminophenol, and 5-amino-o-cresol.

The N-substituted succinimide group containing an isocyanate group may be a group having a structure represented by the following Formula (3).

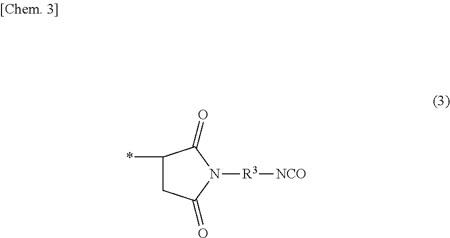

In Formula (3), R³ represents an aliphatic hydrocarbon group, a hydrocarbon group having an aromatic ring, or an organic group having a urethane bond, and * represents a bonding portion.

The modified styrene-based elastomer having an N-substituted succinimide group containing an isocyanate group in the side chain (hereinafter referred to as an “isocyanate group-containing succinimide-modified styrene-based elastomer”) may be a reaction product of maleic anhydride-modified styrene-based elastomer with a diisocyanate compound or a reaction product of a maleic anhydride-modified styrene-based elastomer with an amine compound having an alcoholic hydroxyl group and a diisocyanate compound.

Examples of the diisocyanate compound include diphenylmethane diisocyanate, toluene diisocyanate, hexamethylene diisocyanate, and hexamethylene type diisocyanate having a urethane bond. Examples of the amine compound having an alcoholic hydroxyl group include hydroxyethylamine.

The N-substituted succinimide group containing a blocked isocyanate group may be a group having a structure represented by the following Formula (4).

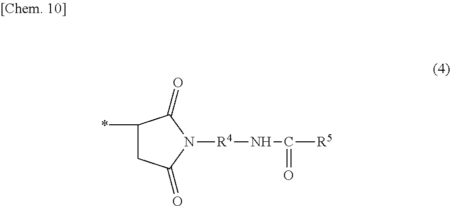

In Formula (4), R⁴ represents a residue of a diisocyanate compound, R⁵ represents a residue of a blocking agent, and * represents a bonding portion. A “residue” refers to the structure of the moiety remaining when a functional group involved in bonding is excluded from a raw material component.

In the modified styrene-based elastomer having an N-substituted succinimide group containing a blocked isocyanate group in the side chain (hereinafter referred to as a “blocked isocyanate group-containing succinimide-modified styrene-based elastomer”), the isocyanate group of the isocyanate group-containing succinimide-modified styrene-based elastomer is protected with a blocking agent.

As the blocking agent, a compound generally known as a blocking agent for an isocyanate group can be used. Examples of the blocking agent include methanol, methyl ethyl ketone oxime, and dimethylpyrazole.

The N-substituted succinimide group containing a maleimide group may be a group having a structure represented by the following Formula (5).

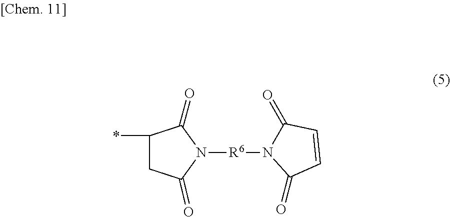

In Formula (5), R⁶ represents a residue of a diamine compound. The modified styrene-based elastomer having an N-substituted

succinimide group containing a maleimide group in the side chain (hereinafter referred to as a “maleimide group-containing succinimide-modified styrene-based elastomer”) may be a reaction product of a maleic anhydride-modified styrene-based elastomer with a diamine compound and maleic anhydride.

Examples of the diamine compound include aliphatic diamines such as polyoxypropylenediamine; and aromatic diamines such as 4,4′-diaminodiphenylmethane, ether, 4,4′-diaminodiphenyl 4,4′-diaminodiphenyl sulfone, 3,3′-diaminodiphenyl sulfone, 4,4′-diaminodiphenyl ketone, 4,4′-diaminobiphenyl, 4,4′-diamino-3,3′-dimethyldiphenylmethane, 4,4′-diamino-3,3′-diethyldiphenylmethane, 2,2-bis(4-aminophenyl) propane, 2,2-bis(4-aminophenyl) hexafluoropropane, and 9,9-bis(4-aminophenyl) fluorene.

The N-substituted succinimide group containing a benzoxazine group may be a group having a structure represented by the following Formula (6).

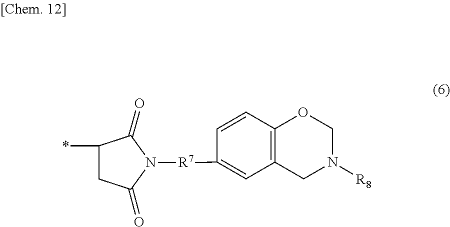

In Formula (6), R⁷ represents an alkylene group, R⁸ represents an alkyl group, a phenyl group, or an allyl group, and * represents a bonding portion. R⁸ is a residue of a monoamine compound.

The modified styrene-based elastomer having an N-substituted succinimide group containing a benzoxazine group in the side chain (hereinafter referred to as “benzoxazine group-containing succinimide-modified styrene-based elastomer”) may be a reaction product of the phenolic hydroxyl group-containing succinimide-modified styrene-based elastomer with paraformaldehyde and a monoamine compound.

Examples of the monoamine compound include aromatic amines such as aniline and aliphatic amines such as allylamine.

### [Resin Composition]

A resin composition can be produced by mixing the modified styrene-based elastomer according to the present embodiment with other components (for example, a thermosetting resin, a curing accelerator, a filler, and a flame retardant). The modified styrene-based elastomer according to the present embodiment exhibits reactivity with respect to a thermosetting resin, and the cured product of the resin composition is excellent in heat resistance, strength, and the like.

### (Thermosetting Resin)

Examples of the thermosetting resin include an epoxy resin, a cyanate ester resin, an acrylic resin, a silicone resin, a phenol resin, a maleimide resin, a thermosetting type polyimide resin, a polyurethane resin, a melamine resin, and a urea resin. These may be used singly or in combination of two or more kinds thereof.

Examples of the epoxy resin include a bisphenol A type epoxy resin, a bisphenol F type epoxy resin, a bisphenol S type epoxy resin, an alicyclic epoxy resin, an aliphatic chain epoxy resin, a phenol novolac type epoxy resin, a cresol novolac type epoxy resin, a bisphenol A novolac type epoxy resin, a phenol aralkyl type epoxy resin, naphthalene skeleton-containing type epoxy resins such as a naphthol novolac type epoxy resin and a naphthol aralkyl type epoxy resin, a bifunctional biphenyl type epoxy resin, a biphenylaralkyl type epoxy resin, a dicyclopentadiene type epoxy resin, and a dihydroanthracene type epoxy resin.

### (Curing Accelerator)

Examples of the curing accelerator include various imidazole compounds, which are latent heat curing agents, BF₃ amine complexes, and phosphorus-based curing accelerators. In a case where a curing accelerator is blended, imidazole compounds and phosphorus-based curing accelerators are preferred from the viewpoints of the storage stability of the resin composition, the handling properties of the semi-cured resin composition, and the solder heat resistance of the cured product.

### (Filler)

Examples of the filler include silica, alumina, titanium oxide, mica, beryllia, barium titanate, potassium titanate, strontium titanate, calcium titanate, aluminum carbonate, magnesium hydroxide, aluminum hydroxide, aluminum silicate, calcium carbonate, calcium silicate, magnesium silicate, silicon nitride, boron nitride, calcined clay, talc, aluminum borate, and silicon carbide. These may be used singly or two or more kinds thereof may be used concurrently.

The shape and particle size of the filler are not particularly limited. The particle size of the filler may be, for example, 0.01 μm to 20 μm or 0.1 μm to 10 μm. Here, the particle size refers to the average particle size, and is the particle size at the point corresponding to 50% volume when a cumulative frequency distribution curve of particle sizes is determined assuming the total volume of the particles to be 100%. The average particle size can be measured using a particle size distribution measuring instrument by a laser diffraction scattering method.

For the purpose of improving the dispersibility of the filler and the close contact properties to an organic component, a coupling agent can be concurrently used if necessary. The coupling agent is not particularly limited, and for example, various silane coupling agents and titanate coupling agents can be used. These may be used singly or two or more kinds thereof may be used concurrently. The amount of the coupling agent used is not particularly limited, and may be, for example, 0.1 parts by mass to 5 parts by mass or 0.5 parts by mass to 3 parts by mass with respect to 100 parts by mass of the filler used. When the amount of the coupling agent used is in this range, the deterioration of various properties is small and the advantages due to the use of the filler are likely to be effectively exerted.

In a case where a coupling agent is used, a so-called integral blending method may be used in which the coupling agent is added after the filler is blended into the resin composition, but a method is preferred in which a filler that has undergone surface treatment with a coupling agent by a dry or wet method in advance is used. By using this method, the advantages of the filler can be more effectively exerted.

### (Flame Retardant)

The flame retardant is not particularly limited, but a bromine-based flame retardant, a phosphorus-based flame retardant, a metal hydroxide and the like are suitably used. Examples of the bromine-based flame retardant include a brominated epoxy resin, a brominated additive flame retardant, and a brominated reactive flame retardant containing an unsaturated double bond group. Examples of the phosphorus-based flame retardant include an aromatic phosphate ester, a phosphonate ester, a phosphinate ester, and a phosphazene compound. Examples of the metal hydroxide flame retardant include magnesium hydroxide and aluminum hydroxide.

The resin composition may be diluted with a solvent, if necessary. The solvent is not particularly limited, but can be determined taking into consideration the volatility during film formation from the viewpoint of the boiling point. Examples of the solvent include solvents having a relatively low boiling point, such as methanol, ethanol, 2-methoxyethanol, 2-ethoxyethanol, 2-butoxyethanol, methyl ethyl ketone, acetone, methyl isobutyl ketone, toluene, and xylene. The solvent may be used singly or in combination of two or more kinds thereof.

The resin composition of the present embodiment can be obtained by uniformly dispersing and mixing the respective components mentioned above, and the means, conditions and the like for the preparation thereof are not particularly limited. For example, a method is mentioned in which the various components are thoroughly and uniformly stirred and mixed in the predetermined blending amounts using a mixer or the like and then kneaded using a mixing roll, an extruder, a kneader, a roll, an extruder, or the like, and further the kneaded product thus obtained is cooled and pulverized. The kneading method is not particularly limited.

### [Resin Film]

A resin film can be produced using the resin composition according to the present embodiment. The resin film refers to an uncured or semi-cured resin composition in the form of a film.

The method for producing the resin film is not limited, but for example, the resin film can be obtained by applying a resin composition onto a supporting base material and drying the formed resin layer. Specifically, the resin composition may be applied onto a supporting base material using a kiss coater, a roll coater, a comma coater, or the like, and then dried in a heating and drying oven, for example, at a temperature of 70° C. to 250° C., preferably 70° C. to 200° C. for 1 minute to 30 minutes, preferably 3 minutes to 15 minutes. A resin film in which the resin composition is in a semi-cured state can be thus obtained.

The resin film in a semi-cured state can be thermally cured by further heating the resin film in a heating oven, for example, at a temperature of 170° C. to 250° C., preferably 185° C. to 230° C. for 60 minutes to 150 minutes.

The thickness of the resin film according to the present embodiment is not particularly limited, but is preferably 1 μm to 200 μm, more preferably 2 μm to 180 μm, and still more preferably 3 μm to 150 μm. By setting the thickness of the resin film in the above range, it is easy to achieve both thinning and favorable high frequency characteristics of a printed wiring board obtained using the resin film according to the present embodiment.

The supporting base material is not particularly limited, but is preferably at least one selected from the group consisting of glass, a metal foil, and a PET film. As the resin film includes a supporting base material, the storage properties and the handling properties when the resin film is used in the production of printed wiring boards tend to be favorable. In other words, the resin film according to the present embodiment can take the form of a support with a resin layer, including a resin layer containing the resin composition according to the present embodiment and a supporting base material, and may be peeled off from the supporting base material at the time of use.

### [Prepreg]

A prepreg can be produced using the resin composition according to the present embodiment. A prepreg can be obtained by applying the resin composition according to the present embodiment to a fiber base material, which is a reinforcing base material, and drying the applied resin composition. The prepreg may be obtained by impregnating a fiber base material with the resin composition according to the present embodiment, and then drying the impregnated resin composition. Specifically, a prepreg in which a resin composition is semi-cured is obtained by heating and drying a fiber base material to which the resin composition is attached in a drying oven usually at a temperature of 80° C. to 200° C. for 1 minute to 30 minutes. From the viewpoint of favorable moldability, it is preferable to coat or impregnate the fiber base material with the resin composition in such an amount that the resin content in the prepreg after drying is 30% to 90% by mass.

The reinforcing base material for the prepreg is not limited, but a sheet-like fiber base material is preferred. Examples of the sheet-like fiber base material include inorganic fibers such as E glass, NE glass, S glass, and Q glass; and organic fibers such as polyimide, polyester, and tetrafluoroethylene. As the sheet-like fiber base material, those having the shape of a woven fabric, a nonwoven fabric, a chopped strand mat, or the like can be used.

### [Laminate]

According to the present embodiment, it is possible to provide a laminate including a resin layer containing a cured product of the above-described resin composition and a conductor layer. For example, the resin film or the prepreg can be used to produce a metal-clad laminate.

The method for producing the metal-clad laminate is not limited, but a metal-clad laminate having a metal foil on at least one surface of a resin layer or prepreg that serves as an insulating layer is obtained by, for example, stacking one or more sheets of the resin film or prepreg according to the present embodiment, disposing a metal foil serving as a conductor layer on at least one surface of the stacked body, and performing heating and pressurization, for example, at a temperature of 170° C. to 250° C., preferably 185° C. to 230° C. and a pressure of 0.5 MPa to 5.0 MPa for 60 minutes to 150 minutes. The heating and pressurization can be performed, for example, under conditions of a vacuum degree of 10 kPa or less, preferably 5 kPa or less, and is preferably performed in a vacuum from the viewpoint of increasing the efficiency. The heating and pressurization are preferably performed for 30 minutes from the start to the time from the start until the completion of molding.

### [Multilayer Printed Wiring Board]

According to the present embodiment, it is possible to provide a multilayer printed wiring board including a resin layer containing a cured product of the above-described resin composition and a circuit layer. The upper limit of the number of circuit layers is not particularly limited, and may be 3 to 20 layers. A multilayer printed wiring board can also be produced using, for example, the resin film, prepreg or metal-clad laminate.

The method for producing the multilayer printed wiring board is not particularly limited, but a multilayer printed wiring board can be produced by, for example, first disposing a resin film on one or both surfaces of a core substrate on which a circuit has been formed, or disposing a resin film between a plurality of core substrates, bonding the respective layers by pressure and heat lamination molding or pressure and heat press molding, and then performing circuit formation processing by laser drilling, drilling, metal plating, metal etching or the like. In a case where the resin film has a supporting base material, the supporting base material can be peeled off before the resin film is disposed on the core substrate or between the core substrates, or can be peeled off after the resin layer is pasted to the core substrate.

The suitable embodiments of the present disclosure have been described above, but these are merely examples for explaining the present disclosure, and it is not intended that the scope of the present invention be limited only to these embodiments. The present invention can be implemented in various forms different from the above-described embodiments without departing from the gist of the present invention.

### EXAMPLES

Hereinafter, the present disclosure will be described in more detail with reference to Examples. However, the present invention is not limited to the following Examples.

### Example A-1

A 1 L flask was charged with 150 g of maleic anhydride-modified hydrogenated styrene-based thermoplastic elastomer (product name “TUFTEC M1913” manufactured by Asahi Kasei Corp.) and 656 g of toluene, and the temperature was raised to 80° C. in about 0.5 hours while stirring was performed, and then maintained at 80° C. for 1 hour to dissolve the “TUFTEC M1913”. Subsequently, the temperature was lowered to 40° C., and a solution prepared by dissolving 4.5 g of tyramine (manufactured by FUJIFILM Wako Pure Chemical Corporation) in 85.5 g of propylene glycol monomethyl ether (PGME) was added dropwise. Thereafter, the temperature was raised to 60° C. in about 0.5 hour while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of a phenolic hydroxyl group-containing succinimide-modified styrene-based elastomer (A-1).

The FT-IR spectrum of (A-1) was measured using an FT-IR spectrometer (product name “IRSpirit” manufactured by SHIMADZU CORPORATION), and it was found that the peak attributed to an acid anhydride group at about 1780 cm⁻¹ disappeared and a peak attributed to an imide group was observed at about 1700 cm⁻¹.

### Example A-2

A 1 L flask was charged with 150 g of “TUFTEC M1913” and 636 g of toluene, and the temperature was raised to 80° C. in about 0.5 hours while stirring was performed, and then maintained at 80° C. for 1 hour to dissolve the “TUFTEC M1913”. Subsequently, the temperature was lowered to 40° C., and a solution prepared by dissolving 5.0 g of dopamine (manufactured by FUJIFILM Wako Pure Chemical Corporation) in 95.0 g of PGME was added dropwise. Thereafter, the temperature was raised to 60° C. in about 0.5 hours while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of a catechol group-containing succinimide-modified styrene-based elastomer (A-2).

The FT-IR spectrum of (A-2) was measured, and it was found that the peak attributed to an acid anhydride group at about 1780 cm⁻¹ disappeared and a peak attributed to an imide group was observed at about 1700 cm⁻¹.

### Example B-1

A 1 L flask was charged with 150 g of “TUFTEC M1913” and 656 g of xylene, and the temperature was raised to 80° C. in about 0.5 hours while stirring was performed, and then maintained at 80° C. for 1 hour to dissolve the “TUFTEC M1913”. Subsequently, the temperature was lowered to 40° C., and a solution prepared by dissolving 3.6 g of diphenylmethane diisocyanate (manufactured by FUJIFILM Wako Pure Chemical Corporation) in 68.4 g of xylene was added dropwise. Thereafter, the temperature was raised to 60° C. in about 0.5 hours while stirring was performed, and then maintained at 60° C. for 1 hour. Furthermore, the temperature was raised to 135° C. in about 1 hour and then maintained at 135° C. for 2 hours while nitrogen was circulated to obtain a toluene solution of an isocyanate group-containing succinimide-modified styrene-based elastomer (B-1).

The FT-IR spectrum of (B-1) was measured, and it was found that the peak attributed to an acid anhydride group at about 1780 cm⁻¹ disappeared, a peak attributed to an imide group was observed at about 1700 cm⁻¹, and a peak attributed to an isocyanate group was observed at about 2260 cm⁻¹.

### Example B-2

A 1 L flask was charged with 150 g of “TUFTEC M1913” and 607 g of xylene, and the temperature was raised to 80° C. in about 0.5 hours while stirring was performed, and then maintained at 80° C. for 1 hour to dissolve the “TUFTEC M1913”. Subsequently, the temperature was lowered to 40° C., and a solution prepared by dissolving 7.0 g of hexamethylene type diisocyanate having a urethane bond (product name “DURANATE D101” manufactured by Asahi Kasei Corp.) in 133 g of xylene was added dropwise. Thereafter, the temperature was raised to 60° C. in about 0.5 hours while stirring was performed, and then maintained at 60° C. for 1 hour. Furthermore, the temperature was raised to 135° C. in about 1 hour and then maintained at 135° C. for 2 hours while nitrogen was circulated to obtain a toluene solution of an isocyanate group-containing succinimide-modified styrene-based elastomer (B-2).

The FT-IR spectrum of (B-2) was measured, and it was found that the peak attributed to an acid anhydride group at about 1780 cm⁻¹ disappeared, a peak attributed to an imide group was observed at about 1700 cm⁻¹, and a peak attributed to an isocyanate group was observed at about 2260 cm⁻¹.

### Example B-3

A 1 L flask was charged with 150 g of “TUFTEC M1913” and 679 g of toluene, and the temperature was raised to 80° C. in about 0.5 hours while stirring was performed, and then maintained at 80° C. for 1 hour to dissolve the “TUFTEC M1913”. Subsequently, the temperature was lowered to 40° C., and a solution prepared by dissolving 2.0 g of ethanolamine in 38 g of PGME was added dropwise. Thereafter, the temperature was raised to 60° C. in about 0.5 hours while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of an ethanolic hydroxyl group-containing succinimide-modified styrene-based elastomer.

To the toluene solution of an ethanolic hydroxyl group-containing succinimide-modified styrene-based elastomer, 6.0 g of diphenylmethane diisocyanate was added, and the reaction was conducted at 90° C. for 2 hours to obtain a toluene solution of a succinimide-modified styrene-based elastomer having an isocyanate group and a urethane bond (B-3).

The FT-IR spectrum of (B-3) was measured, and it was found that the peak attributed to an acid anhydride group at about 1780 cm⁻¹ disappeared, a peak attributed to an imide group was observed at about 1700 cm⁻¹, a peak attributed to a urethane bond was observed at about 1730 cm⁻¹, and a peak attributed to an isocyanate group was observed at about 2260 cm⁻¹.

### Example B-4

To the toluene solution of a succinimide-modified styrene-based elastomer having an ethanolic hydroxyl group, 10.3 g of “DURANATE D101” was added, and the reaction was conducted at 90° C. for 2 hours to obtain a toluene solution of a succinimide-modified styrene-based elastomer having an isocyanate group and a urethane bond (B-4).

The FT-IR spectrum of (B-4) was measured, and it was found that the peak attributed to an acid anhydride group at about 1780 cm⁻¹ disappeared, a peak attributed to an imide group was observed at about 1700 cm⁻¹, a peak attributed to a urethane bond was observed at about 1730 cm⁻¹, and a peak attributed to an isocyanate group was observed at about 2260 cm⁻¹.

### Example C-1

To the toluene solution of (B-1) above, 0.1 g of methanol (manufactured by FUJIFILM Wako Pure Chemical Corporation) was added, and the reaction was conducted at 90° C. for 2 hours to obtain a toluene solution of a succinimide-modified styrene-based elastomer having a blocked isocyanate group (C-1).

The FT-IR spectrum of (C-1) was measured, and it was found that the peak attributed to an isocyanate group at about 2260 cm⁻¹ disappeared.

### Example C-2

A toluene solution of a blocked isocyanate group-containing succinimide-modified styrene-based elastomer (C-2) was obtained in the same manner as (C-1) except that 0.1 g of methanol was changed to 0.2 g of methyl ethyl ketone oxime (manufactured by FUJIFILM Wako Pure Chemical Corporation).

The FT-IR spectrum of (C-2) was measured, and it was found that the peak attributed to an isocyanate group at about 2260 cm⁻¹ disappeared.

### Example C-3

A toluene solution of a blocked isocyanate group-containing succinimide-modified styrene-based elastomer (C-3) was obtained in the same manner as (C-1) except that 0.1 g of methanol was changed to 0.2 g of dimethylpyrazole (manufactured by FUJIFILM Wako Pure Chemical Corporation).

The FT-IR spectrum of (C-3) was measured, and it was found that the peak attributed to an isocyanate group at about 2260 cm⁻¹ disappeared.

### Example D-1

In a 1 L flask equipped with a condenser, a nitrogen introducing tube, a thermocouple, and a stirrer, 688 g of toluene and 150 g of “TUFTEC M1913” were charged, heated to 80° C., and dissolved for 1.0 hour while being stirred. Subsequently, the internal temperature of the flask was lowered to 30° C., and a solution prepared by dissolving 9.3 g of 2,2-bis(4-aminophenyl) hexafluoropropane (manufactured by Tokyo Chemical Industry Co., Ltd.) in 9.3 g of toluene was added dropwise, and stirring was performed for 1.0 hour. Thereafter, 2.8 g of maleic anhydride (manufactured by FUJIFILM Wako Pure Chemical Corporation) was added, and further the temperature was maintained for 1.0 hour. After 0.53 g of p-toluenesulfonic acid was added, the internal temperature of the flask was raised to the reflux temperature (about 110° C.), and the dehydration and cyclization reaction was conducted for 3.0 hours while nitrogen was circulated to obtain a toluene solution of a maleimide group-containing succinimide-modified styrene-based elastomer (D-1).

The FT-IR spectrum of (D-1) was measured, and it was found that the peak attributed to an acid anhydride group at about 1780 cm⁻¹ disappeared and a peak attributed to an imide group was observed at about 1700 cm⁻¹. The ¹³C-NMR spectrum (manufactured by Bruker Corporation) of (D-1) was measured, and it was found that 2 to 3 peaks attributed to the carbonyl carbon of a succinimide group and the carbonyl carbon of a maleimide group appeared in the region of 170 ppm to 180 ppm.

### Example D-2

In a 1 L flask equipped with a condenser, a nitrogen introducing tube, a thermocouple, and a stirrer, 722 g of toluene and 150 g of “TUFTEC M1913” were charged, heated to 80° C., and dissolved for 1.0 hour while being stirred. Subsequently, the internal temperature of the flask was lowered to 30° C., and a solution prepared by dissolving 6.6 g of polyoxypropylenediamine (product name “Jeffermine D230” manufactured by Huntsman Corporation) in 6.6 g of toluene was added dropwise, and stirring was performed for 1.0 hour. Thereafter, 2.8 g of maleic anhydride was added, and further the temperature was maintained for 1.0 hour. After 0.53 g of p-toluenesulfonic acid was added, the internal temperature of the flask was raised to the reflux temperature (about 110° C.), and the dehydration and cyclization reaction was conducted for 3.0 hours while nitrogen was circulated to obtain a toluene solution of a maleimide group-containing succinimide-modified styrene-based elastomer (D-2).

The FT-IR spectrum of (D-2) was measured, and it was found that the peak attributed to an acid anhydride group at about 1780 cm⁻¹ disappeared and a peak attributed to an imide group was observed at about 1700 cm⁻¹. The ¹³C-NMR spectrum of (D-2) was measured, and it was found that 2 to 3 peaks attributed to the carbonyl carbon of a succinimide group and the carbonyl carbon of a maleimide group appeared in the region of 170 ppm to 180 ppm.

### Example D-3

In a 1 L flask equipped with a condenser, a nitrogen introducing tube, a thermocouple, and a stirrer, 692 g of toluene and 150 g of “TUFTEC M1913” were charged, heated to 80° C., and dissolved for 1.0 hour while being stirred. Subsequently, the internal temperature of the flask was lowered to 30° C., and a solution prepared by dissolving 5.5 g of 4,4-methylenedianiline (Tokyo Chemical Industry Co., Ltd.) in 5.5 g of toluene was added dropwise, and stirring was performed for 1.0 hour. Thereafter, 2.8 g of maleic anhydride was added, and further the temperature was maintained for 1.0 hour. After 0.53 g of p-toluenesulfonic acid was added, the internal temperature of the flask was raised to the reflux temperature (about 110° C.), and the dehydration and cyclization reaction was conducted for 3.0 hours while nitrogen was circulated to obtain a toluene solution of a maleimide group-containing succinimide-modified styrene-based elastomer (D-3).

The FT-IR spectrum of (D-3) was measured, and it was found that the peak attributed to an acid anhydride group at about 1780 cm⁻¹ disappeared and a peak attributed to an imide group was observed at about 1700 cm⁻¹. The ¹³C-NMR spectrum of (D-3) was measured, and it was found that 2 to 3 peaks attributed to the carbonyl carbon of a succinimide group and the carbonyl carbon of a maleimide group appeared in the region of 170 ppm to 180 ppm.

### Example D-4

In a 1 L flask equipped with a condenser, a nitrogen introducing tube, a thermocouple, and a stirrer, 692 g of toluene and 150 g of “TUFTEC M1913” were charged, heated to 80° C., and dissolved for 1.0 hour while being stirred. Subsequently, the internal temperature of the flask was lowered to 30° C., and a solution prepared by dissolving 5.6 g of 4,4′-diaminodiphenyl ether (manufactured by Tokyo Chemical Industry Co., Ltd.) in 5.6 g of toluene was added dropwise, and stirring was performed for 1.0 hour. Thereafter, 2.8 g of maleic anhydride was added, and further the temperature was maintained for 1.0 hour. After 0.53 g of p-toluenesulfonic acid was added, the internal temperature of the flask was raised to the reflux temperature (about 110° C.), and the dehydration and cyclization reaction was conducted for 3.0 hours while nitrogen was circulated to obtain a toluene solution of a maleimide group-containing succinimide-modified styrene-based elastomer (D-4).

The FT-IR spectrum of (D-4) was measured, and it was found that the peak attributed to an acid anhydride group at about 1780 cm⁻¹ disappeared and a peak attributed to an imide group was observed at about 1700 cm⁻¹. The ¹³C-NMR spectrum of (D-4) was measured, and it was found that 2 to 3 peaks attributed to the carbonyl carbon of a succinimide group and the carbonyl carbon of a maleimide group appeared in the region of 170 ppm to 180 ppm.

### Example E-1

In a 1 L flask equipped with a condenser, a nitrogen introducing tube, a thermocouple, and a stirrer, 672 g of toluene and 150 g of “TUFTEC M1913” were charged, heated to 80° C., and dissolved for 1.0 hour while being stirred. Thereafter, the internal temperature of the flask was lowered to 40° C., and a solution prepared by dissolving 3.8 g of tyramine in 72.2 g of PGME was added dropwise. Thereafter, the temperature was raised to 60° C. in about 0.5 hours while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of a phenolic hydroxyl group-containing succinimide-modified styrene-based elastomer. Thereafter, 2.6 g of aniline (manufactured by Tokyo Chemical Industry Co., Ltd.) and 1.6 g of paraformaldehyde were added, the internal temperature of the flask was raised to the reflux temperature (about 110° C.), and the dehydration and cyclization reaction was conducted for 3.0 hours while nitrogen was circulated to obtain a toluene solution of a benzoxazine group-containing succinimide-modified styrene-based elastomer (E-1).

The FT-IR spectrum of (E-1) was measured, and it was found that the peak attributed to an acid anhydride group at about 1780 cm⁻¹ disappeared, a peak attributed to an imide group was observed at about 1700 cm⁻¹, and peaks attributed to a benzoxazine group were observed at about 1029 cm⁻¹ and 1232 cm⁻¹.

### Example E-2

A toluene solution of a benzoxazine group-containing succinimide-modified styrene-based elastomer (E-2) was obtained in the same manner as (E-1), except that 2.6 g of aniline was changed to 1.6 g of allylamine (manufactured by Tokyo Chemical Industry Co., Ltd.).

The FT-IR spectrum of (E-2) was measured, and it was found that the peak attributed to an acid anhydride group at about 1780 cm⁻¹ disappeared, a peak attributed to an imide group was observed at about 1700 cm⁻¹, and peaks attributed to a benzoxazine group were observed at about 1029 cm⁻¹ and 1232 cm⁻¹.

1. A modified styrene-based elastomer having an N-substituted succinimide group containing a phenolic hydroxyl group, an isocyanate group, a blocked isocyanate group, a maleimide group, or a benzoxazine group in a side chain.

2. The modified styrene-based elastomer according to claim 1, wherein the N-substituted succinimide group has a structure represented by the following Formula (1): 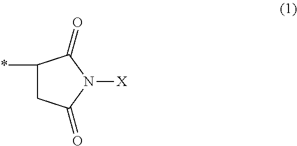
wherein in Formula (1), X represents a monovalent organic group having a phenolic hydroxyl group, an isocyanate group, a blocked isocyanate group, a maleimide group, or a benzoxazine group, and * represents a bonding portion.

3. The modified styrene-based elastomer according to claim 1, wherein the N-substituted succinimide group containing a phenolic hydroxyl group has a structure represented by the following Formula (2): 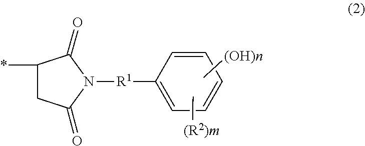
wherein in Formula (2), R¹ represents an alkylene group or a single bond, R² represents an alkyl group, m is 0 or 1, n is 1 or 2, and * represents a bonding portion.

4. The modified styrene-based elastomer according to claim 1, wherein the N-substituted succinimide group containing an isocyanate group has a structure represented by the following Formula (3): 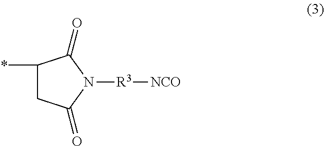
wherein in Formula (3), R³ represents an aliphatic hydrocarbon group, a hydrocarbon group having an aromatic ring, or an organic group having a urethane bond, and * represents a bonding portion.

5. The modified styrene-based elastomer according to claim 1, wherein the N-substituted succinimide group containing a blocked isocyanate group has a structure represented by the following Formula (4): 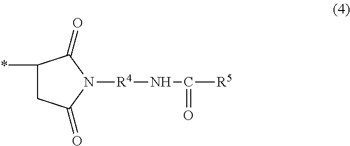
wherein in Formula (4), R⁴ represents a residue of a diisocyanate compound, R⁵ represents a residue of a blocking agent, and * represents a bonding portion.

6. The modified styrene-based elastomer according to claim 1, wherein the N-substituted succinimide group containing a maleimide group has a structure represented by the following Formula (5): 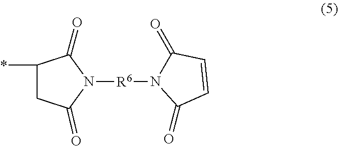
wherein in Formula (5), R⁶ represents a residue of a diamine compound.

7. The modified styrene-based elastomer according to claim 1, wherein the N-substituted succinimide group containing a benzoxazine group has a structure represented by the following Formula (6): 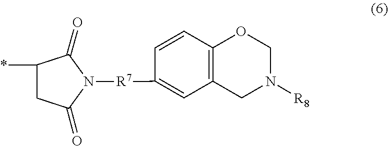
wherein in Formula (6), R⁷ represents an alkylene group, R⁸ represents an alkyl group, a phenyl group, or an allyl group, and * represents a bonding portion.
